(19) United States
(12) Patent Application Publication
(10) Pub. No.: US 2004/0200068 A1
(43) Pub. Date: Oct. 14, 2004

(54) Positioning of flat conductors

(76) Inventor: Nikola Dragov, Maria Enzersdorf (AT)

Correspondence Address: MERCHANT & GOULD PC, P.O. BOX 2903, MINNEAPOLIS, MN, 55402-0903, US

(21) Appl. No.: 10/488,565

(22) PCT Filed: Jul. 2, 2003
(86) PCT No.: PCT/AT03/00184

(30) Foreign Application Priority Data
Jul. 2, 2002 (AT) A 987/2002

(51) Int. Cl. B23P 19/00

(52) U.S. Cl. 29/868; 29/749; 29/867; 29/872

(57) ABSTRACT

The invention concerns a method for positioning of the stripped sites of two flat flexible cables (FFC) to be mechanically and electrically connected to each other.

The invention is characterized by the fact that the stripped sites of the two flat flexible cables being joined are optically detected, both in terms of their location, on the corresponding flat flexible cable, and also according to their shape and size, that they are positioned one on the other, so that, in a first variant, the smallest of the overlapping stripped surfaces will be a maximum.

In a second variant, positioning occurs so that the largest current density occurring in one of the overlapping stripped surfaces will be a minimum.

The invention also concerns an apparatus for execution of the method.

The invention concerns the positioning of flat flexible cables (FFC); more precisely, the positioning of stripped sites of two flat flexible cables to be electrically and mechanically connected relative to each other.

The preparation of stripped areas, so-called windows, of flat flexible cables to be electrically connected to each other is done manually in the prior art, and almost always comprises only one, in rare cases, a maximum of two, conductor strips per FFC, since the production of the windows cannot be done with sufficient accuracy to enable the now existing automatic equipment to arrive at a degree of overlap of the bare conductors exposed in the windows that would be sufficient for the corresponding current load.

According to the invention, an improvement in the accuracy of connection and therefore improvement in conductivity is achieved by using an image processing device in the positioning and connection process of flat flexible cables. The advantage of the invention is demonstrated below by a worst-case estimate for both methods; the conventional, previously used method, which, however, does not represent a previously published prior art, but the internal knowledge of the applicant; and the image processing method.

The invention is further explained below by means of drawings. In the drawings

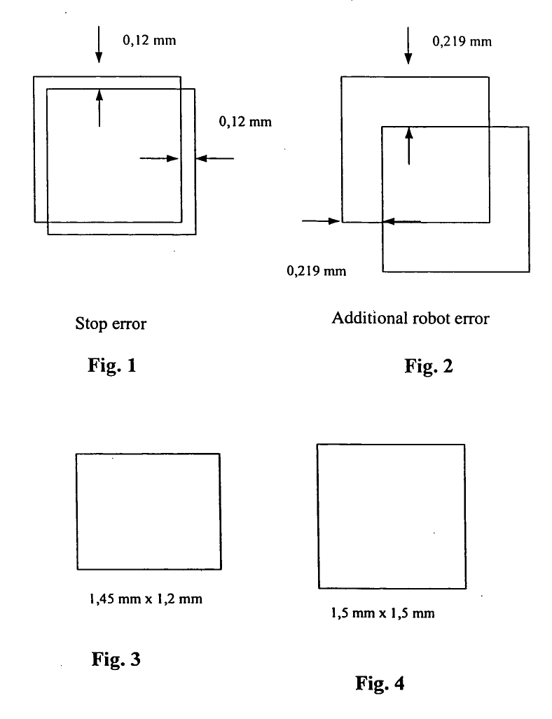

FIG. 1 shows the effects of stop error,

FIG. 2 shows the additional effects of robot error,

FIGS. 3 and 4 show the effects of initial data error,

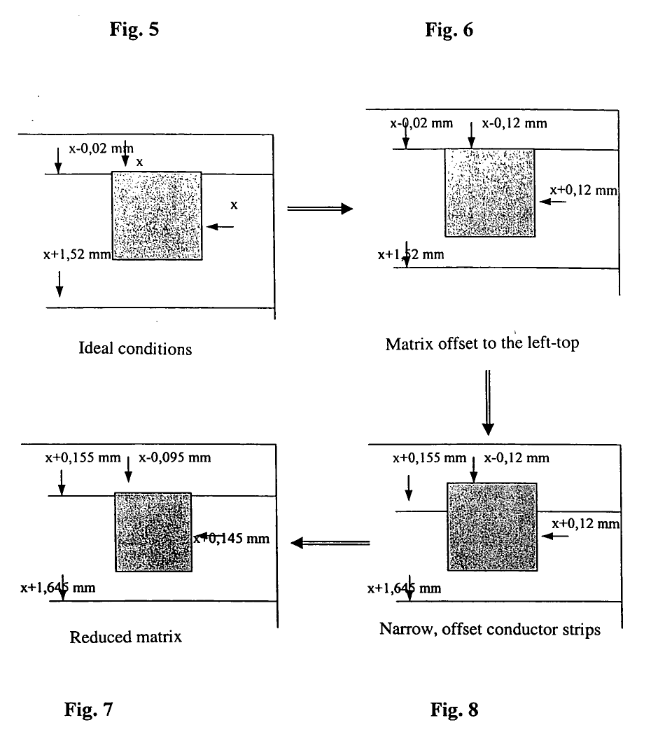

FIGS. 5 to 8 show the formation of coincidence error,

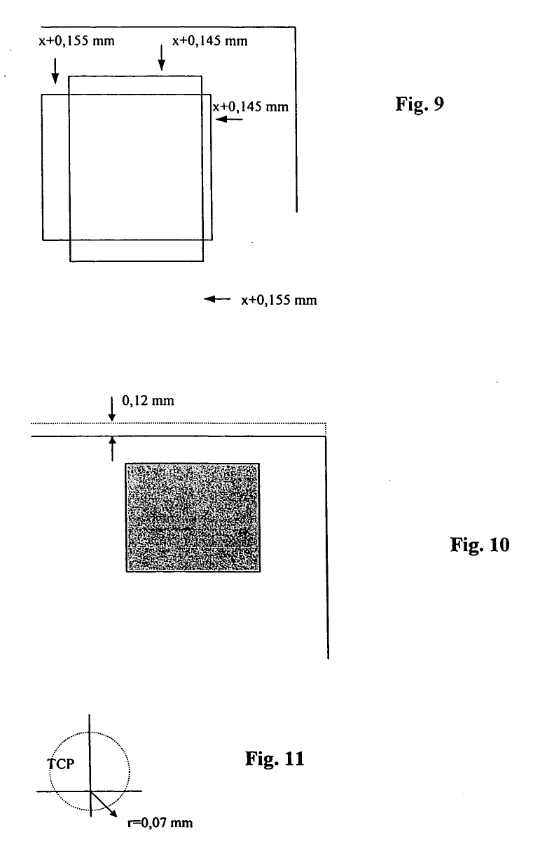

FIG. 9 shows the overlap error,

FIG. 10 shows the stop error,

FIG. 11 shows the robot error,

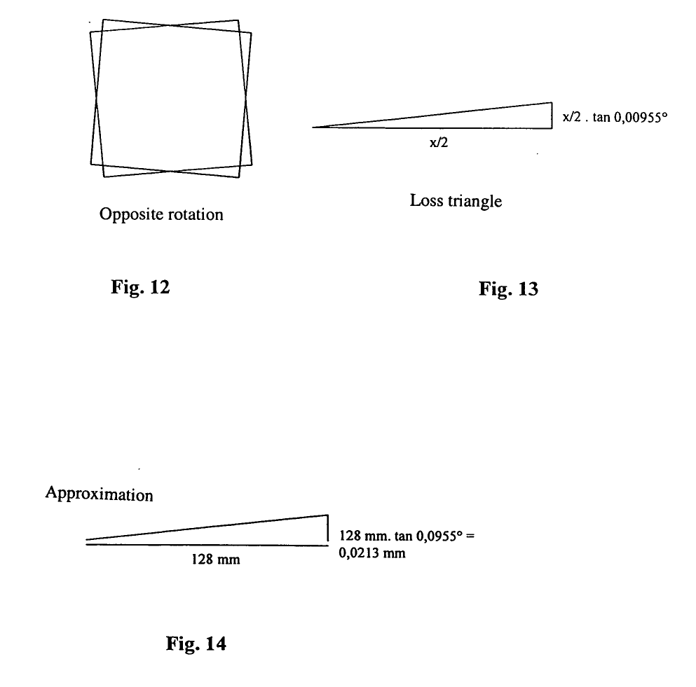

FIGS. 12 to 14 show the effects of rotations,

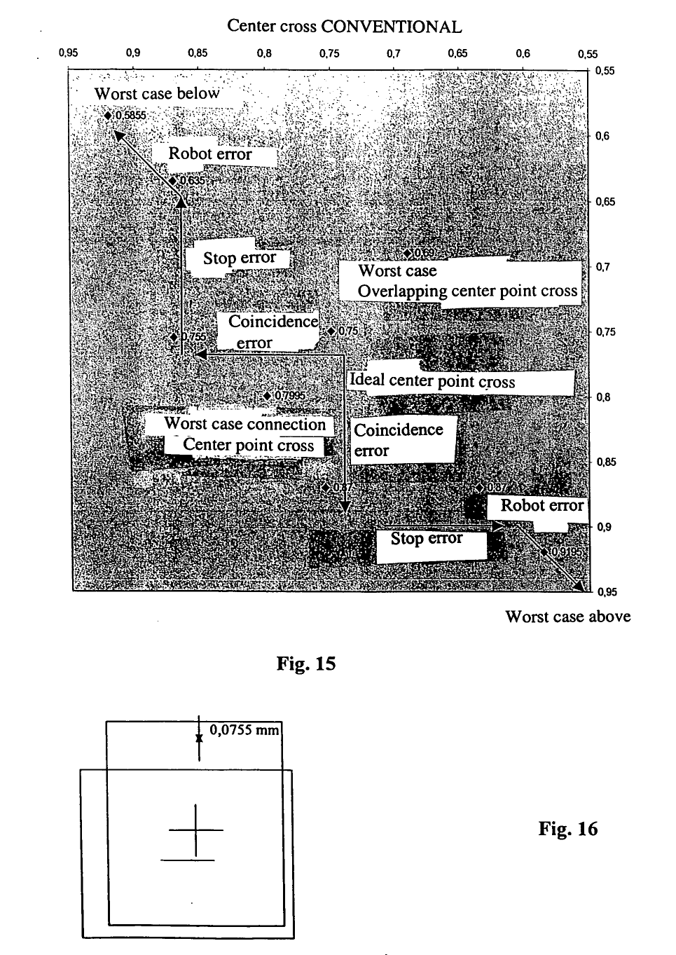

FIG. 15 shows the effect of combination of individual errors,

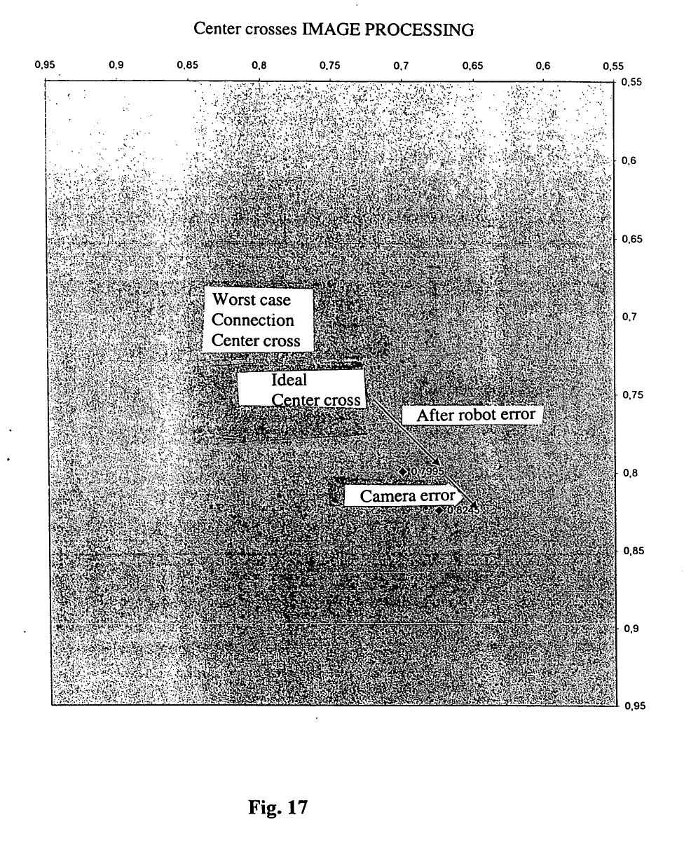

FIG. 16 shows the situation of an individual window during the image processing method,

FIG. 17 shows the combinations of individual errors in the image processing method,

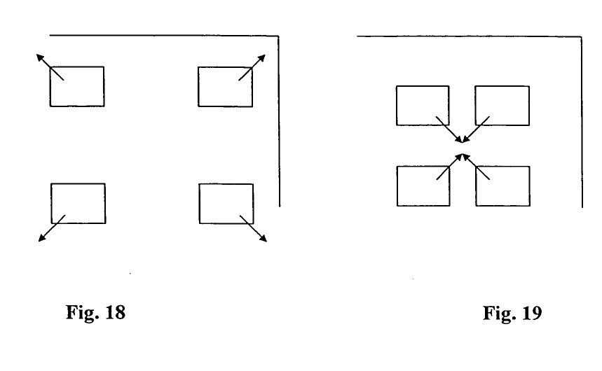

FIGS. 18 and 19 show the theoretical situation in several windows,

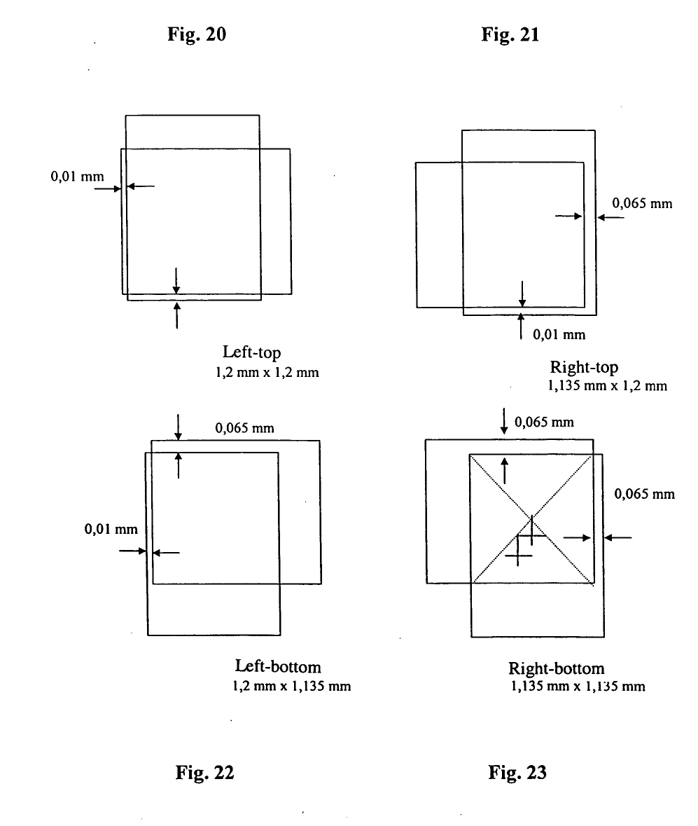

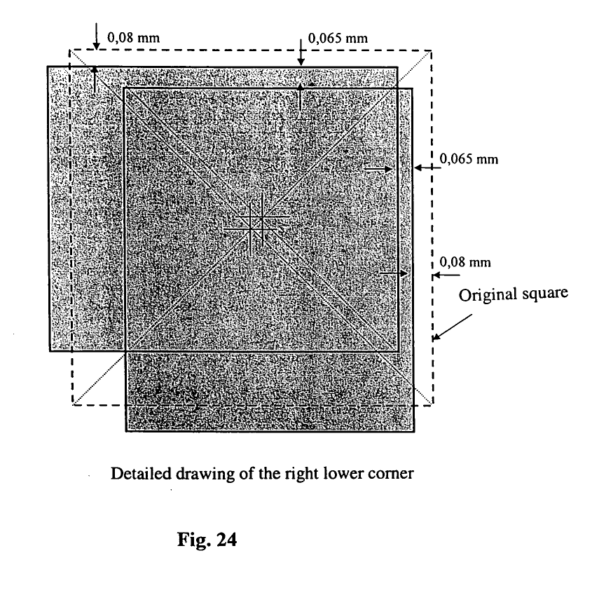

FIGS. 20 to 24 show the effects on individual windows,

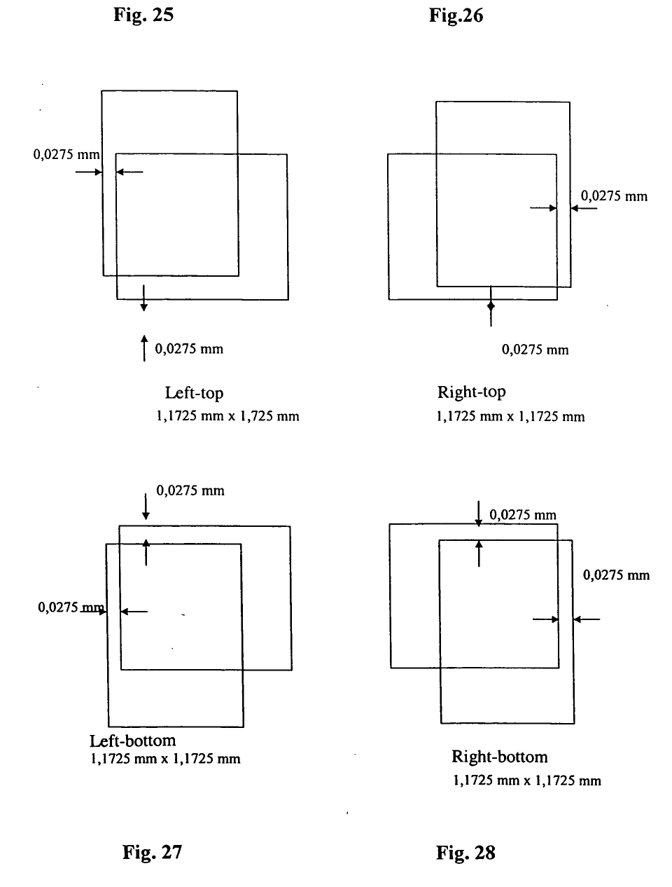

FIGS. 25 to 28 show views similar to FIGS. 20 to 24, but in the image processing method,

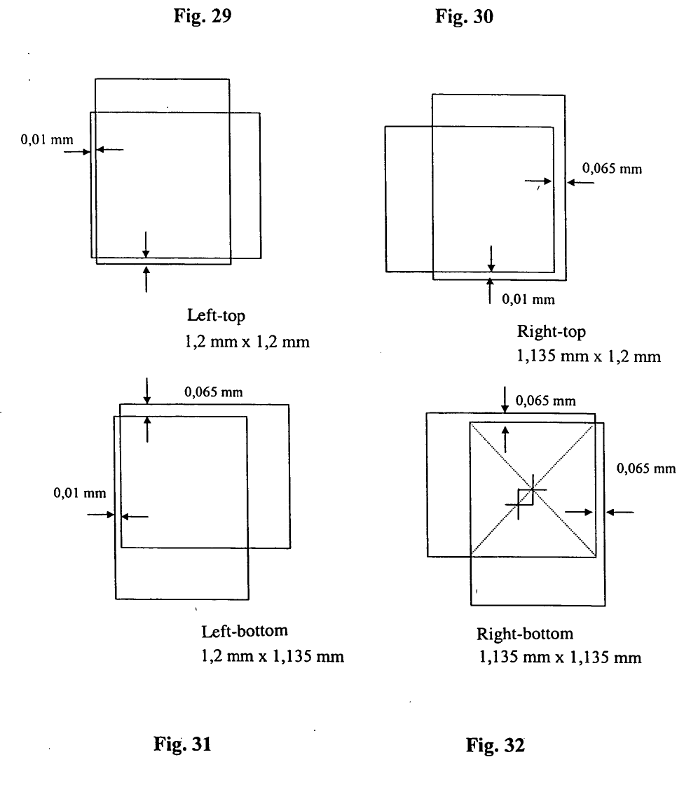

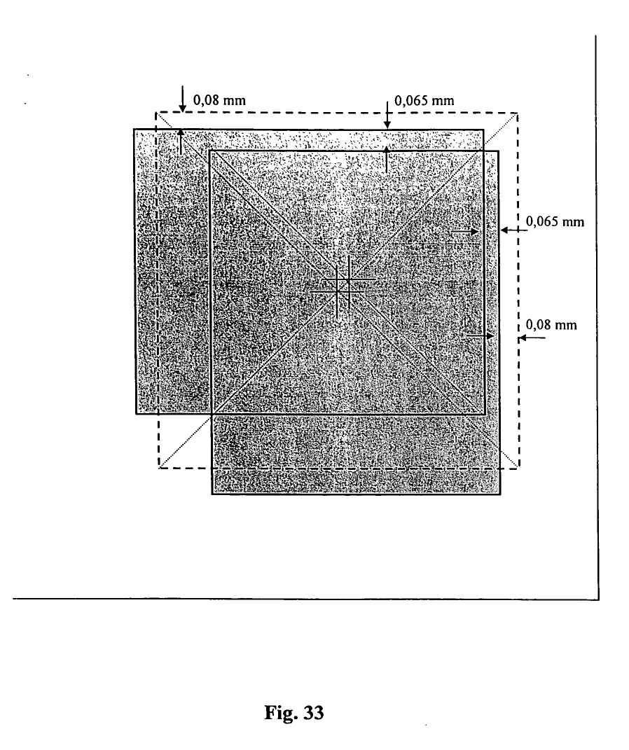

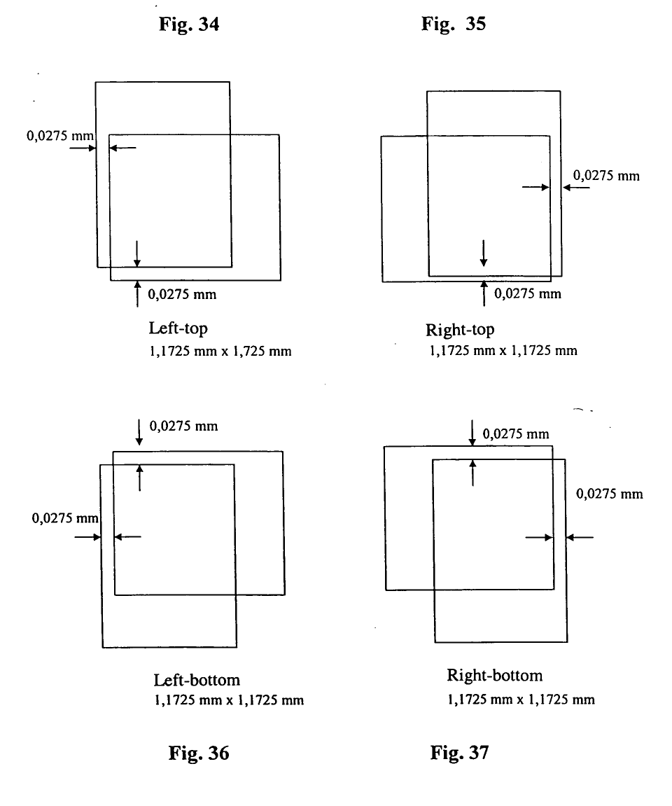

FIGS. 29 to 32 and 33, on the one hand, and FIGS. 34 to 37, on the other hand, show views of overlapping of the windows in the conventional and in the image processing methods.

Initially, the more unfavorable case, in which no deviations occur during production, is treated for image processing. In order to be better than the conventional process here with image processing, the camera must deviate in accuracy by no more than 0.08475 mm.

The effect of rotation of the positioning robot is also estimated, as is the theoretical possibility of causing a short circuit by connecting two conductor strips. During cable production, the worst possible values are used as the point of departure, which, however, still lie within the tolerance range. These deviations during production are referred to as initial data errors.

Both methods are analyzed below in individual window consideration and in the far more practical matrix consideration:

Individual windows:

| Error type | Conventional method | Image processing method |
|---|---|---|
| Initial data errors | 77.33% | 77.33% |
| After coincidence error | 64.00% | 64.00% |
| After stop error | 52.80% | — |
| After robot error | 43.65% | 64.00% |
| After camera error | — | 64.00% |

Matrix Consideration:

| Error type | Conventional method | Image processing method |
|---|---|---|
| Initial data errors | 77.33% | 77.33% |
| After coincidence error | 57.25% | 61.10% |
| After stop error | 45.79% | — |
| After robot error | 37.29% | 56.05% |
| After camera error | — | 51.17% |

The center crosses and the effects of individual errors on the displacement of these crosses can be represented most simply by graphs in a coordinate system.

If the camera error lies below the value of 0.08475 mm, the image processing method, in all cases, is superior to the conventional system in accuracy.

The increase in common contact surface, which represents a gauge of the improvement in accuracy, can be summarized as follows:

| Estimate | Dimensions | Improvement |
|---|---|---|
| Consideration without tolerances | 1.281 mm × | 16.34% |
| | 1.281 mm→ | |
| | 1.4005 mm × 1.4005 mm | |
| Individual widow analysis | 0.991 mm × | 31.80% |
| | 0.991 mm→ | |
| | 1.20 mm × 1.20 mm | |
| Matrix analysis | 0.916 mm × | 27.12% |
| | 0.916 mm→ | |
| | 1.073 mm × 1.073 mm | |

A major advantage of image processing is also, ultimately, identification of defective products and the possibility of establishing a threshold value for the common contact surface, whereby workpiece(s) falling short of said threshold can be discarded.

Considerations Concerning “Matrix Positioning”

### 1. Description of the Work Procedures

1.1 Conventional Method (Existing, but Unpublished System)

Production of workpieces—the errors that appear lie both in the tolerances of the strip conductor strips and the offset of the matrix, which is attributed to inaccuracy of the laser during production. For calculation of the maximum error that still lies within the tolerance range, the data sheets for FFC of the applicant were used.

Stop—the connection process starts with positioning of the lower flat flexible cable against a stop. This deviation from the ideal stop (stop error) is also taken from the data sheet and represents the lateral tolerance of ±0.12 mm lying outside of the copper strips.

Robot positioning—a robot grasps the flat flexible cable and positions it by means of suction cups on the carrier. The inaccuracies of positioning of the robot gripper are then included in the calculation. An estimate of the repetition accuracy and rotation error must be made.

Stop—the second (upper) flat flexible cable is placed against the stop. The same tolerance estimates as for the first stop error apply.

Robot positioning—the second flat flexible cable is positioned on the carrier by the robot gripper. This cable undergoes a rotation of 90° relative to the first (lower) flat flexible cable.

Connection—the flat flexible cables are connected conducting on the carrier at the defined and exposed copper windows by a bonding or shape-mating connection method. Welding, soldering, crimping or similar methods can be used as the connection methods if they produce an electrically conductive connection. Since the same robot arm as for positioning is used, the same error estimate can be used.

1.2 Image Processing Method

Production of workpieces—the same assumptions as for the conventional production process are made for production and positioning of the matrix itself.

Stop—the first flat flexible cable is also placed against the stop in the image processing method. Errors that occur here are interpreted by the camera as translation of rotation of the matrix on the flat flexible cable and are compensated. The stop error is not included in accuracy in the image processing method.

Robot positioning—the robot gripper positions the first workpiece on the carrier. Errors that occur here are interpreted by the camera as translation of rotation of the matrix on the flat flexible cable and are compensated. The robot error is not included in accuracy in the image processing method in the first flat flexible cable.

Image processor—the flat flexible cable lying on the carrier is recorded by the camera with reflected light and/or back-lighting. The window size, the matrix structure and the position of the window with reference to the conductor strip are then determined. Image processing calculates a center cross of the matrix and center crosses of the individual detected copper windows. The camera error is included in the calculation.

Stop—the second (upper) flat flexible cable is placed against the stop. Here again, image processing compensates for any error and the inaccuracy is uninfluenced by this operating step.

Robot positioning—the robot gripper holds the second flat flexible cable with the contact side in the camera. Any positioning errors are compensated by the camera.

Image processing—the flat flexible cable held in the camera is recorded by the camera in reflected light and/or by the back-lighted method. The window size, the matrix structure and the position of the windows with reference to the conductor strips are then determined. Image processing calculates a center cross of the matrix and center crosses of the individual detected copper windows. The camera error is included in the calculation.

Calculation—the trajectory to transfer the center cross of the matrix of the upper flat flexible cable into that of the lower flat flexible cable is calculated. No error is assumed in the calculation.

Robot positioning—the robot gripper positions the second workpiece according to the calculated trajectory after a 90° rotation above the first cable. This operating step can no longer be checked by the camera and errors that occur enter into accuracy in the second robot positioning, just as in the conventional process.

Connection—on the carrier, the flat flexible cables are conductively connected by a connection process at the defined and exposed copper windows. Since the same robot arm is used as for positioning, the same error estimate can be used.

1.3 Fixed Values

The stop error is assumed at ±0.12 mm from the data sheet.

For robot positioning (robot error), the estimate of a repetition accuracy of 0.07 mm, referred to TCP (tool center point), applies. During one rotation, the robot gripper deviates by no more than 0.05 mm at a cable length of 600 mm.

The I&T FFC data sheet was used as the basis for the tolerances in cable production.

Although a subpixel-accurate edge detection is achieved by means of image processing based on algorithms, the deviation of a full pixel (now 0.025 mm) is assumed as the worst case for the camera error.

### 2. Estimate Without Tolerances During Production of Flat Flexible Cables

The image processing method recognizes several errors during the entire production process and can compensate for them. The larger these errors, the greater the improvement of the image processing method relative to the outlined conventional (but unpublished) method. The behavior and function of both production processes at optimal initial conditions will now be estimated, i.e., no tolerances during production of the cable.

2.1. Conventional (but Unpublished) Method

Assuming that both the conductor strips and the matrix are correctly positioned, in the conventional production process the only restriction on accuracy is twice the stop error and the robot error.

The consideration occurs for the smallest possible individual windows, a 1.5 mm×1.5 mm window.

Since the stop error can occur on both flat flexible cables, in each case one loses 0.12 mm in height and to the side from the common covering surface of the copper square.

FIG. 1 Stop error

FIG. 2 Additional robot error

The window is reduced by the stop error to a 1.38 mm×1.38 window, which still represents 84.64% of the original contact surface.

The robot error during positioning of the workpieces, in the worst case, causes a further drifting apart of the squares by 0.07 mm·sin 45°=0.0495 mm according to side and height.

The cover window is therefore reduced to 1.281 mm×1.281 mm, or to 72.93% of the original surface.

2.2 Image Processing

The stop error in both flat flexible cables is compensated by image processing.

The robot error occurs only once (during positioning of the second cable after image processing). The window is then reduced to a 1.4505 mm×1.4505 mm square that has 93.51% of the original surface.

In the processing method with image processing, the camera error restricts the accuracy for both workpieces.

In order to achieve better results in this estimate without manufacturing tolerances of the cable with the method of image processing than with the previously used method, the camera errors must be less than 0.08475 mm. The same lower limits for camera error are also obtained for other individual window sizes (to 19 mm×19 mm according to the data sheet).

This value is far fallen short of even under the worst-case assumption of a deviation of a full pixel of 0.025 mm and leads to a contact surface square of 1.4005 mm×1.4055 mm, or 87.17% of the original surface.

The improvement of the image processing method relative to the conventional method is therefore 16.34%.

### 3. Error of the Conventional (but Unpublished) Method

3.1 Initial Data Errors

For a worst-case estimate, the deviations that occur during production of flat flexible cables must be counted among the errors in the connection process.

The sum of the errors that occur during cable production are referred to here as initial data errors, since both the conventional method and the image processing method are subject to these conditions.

The following tolerances have an effect during production:

Conductor strip offset (±0.15 mm)

Conductor thickness change (±0.05 mm)

Matrix offset (±0.12 mm)

Window size change (±0.05 mm)

For a worst-case estimate, one assumes in a 1.5 mm×1.5 mm window a conductor strip offset and a matrix offset shifted maximally relative to each other. In addition, both the window size and strip conductor thickness are reduced to a minimum. Such a worst-case window has only 1.45 mm×1.2 mm dimensions, instead of 1.5 mm×1.5 mm, and the visible copper surface is reduced to 77.33%.

FIG. 3 and FIG. 4 Initial data error

3.2 Coincidence Error

In order to calculate the coincidence error, assuming worst-case conditions with the initial data error from point 3.1, the individual steps are given in detail for each contact surface reduction that occurs, which lead to the maximum deviation. It is apparent that the common contact surface has a minimum, if the copper windows of both cables have a size of 1.45 mm×1.20 mm and are shifted maximally to the left and up.

This conclusion is obtained by the following assumptions:

FIG. 5, 6, 7, 8 Coincidence Errors

For connection of the two flat flexible cables, the second workpiece is turned, rotated 90° and positioned on the first workpiece. If the same position dimensions apply to both flat flexible cables, in the worst case, overlapping appears as follows:

FIG. 9 Overlap Errors

The full overlapping on the narrow side is also stipulated in the worst case (thus far, only manufacturing tolerances and coincidence errors were considered). The contact surface is a 1.2 mm×1.2 mm window that therefore still has a surface of 64% of the original window size.

3.3 Stop Error

The stop error then has the greatest effect on accuracy, if both the lower and also the upper flat flexible cable stop is too narrow by the full tolerance of 0.12 mm. For the worst case consideration in the conventional method, it must then be assumed that this deviation can be found in both workpieces.

FIG. 10 Stop Error

By 90° rotation of the upper flat flexible cable, the copper contact surface is reduced by the stop error by 0.12 mm in height and to the side. The resulting contact surface, in the worst case consideration, is 1.09 mm×1.09 mm square that still only has 52.80% of the original size.

3.4 Robot Error (Positioning Accuracy)

The repetition accuracy of the positioning robot is stipulated at 0.07 mm, relative to the TCP. In combination with the other errors, the worst case occurs when the deviation vectors point left-up or right-down relative to each other in the coordinates.

FIG. 11 Robot Errors

The largest contact surface reduction is therefore characterized by a reduction in side lengths of the contact surface square by 0.07 mm·sin 45°=0.0495 mm.

Finally, after considering all (maximum possible) errors, there results a 0.991 mm×0.991 mm square. The copper-copper contact surface is then only 43.65% of the original contact surface!

### 4. Further Estimates

4.1 Short Circuit

It is investigated whether, during maximum exploitation of the tolerances, a case can occur in which a window can be applied over two different strip conductors and thus lead to a short circuit after connection.

If one takes the value x as the ideal state between two strips, in the worst case the strip spacing is x−0.20 mm, since the strip spacing according to the data sheet is assumed as 0.15 mm too small and the strip thickness 0.05 mm too wide.

The window applied with the laser can be 0.05 mm too large and 0.12 mm too deep (or too high) on the flat flexible cable. These deviations together give a strip spacing of x−0.345 mm. Since the spacing of the strips, in practice, lies above 1 mm (i.e., well above 0.345 mm), even in the most unfavorable case, no short circuit can occur while within tolerance.

4.2 Effects of Rotation in the Robot Gripper

4.2.1 Individual Window Analysis

For the maximum rotation error, a deviation of 0.05 mm for a 600 mm long workpiece is given.

The error angle is consequently

$$α = {tan}^{- 1} \frac{0.05 mm}{600 mm} {0.00477}^{∘}$$

In the worst case, opposite rotation around this error angle occurs and therefore a relative rotation by 0.00955° between the squares.

FIG. 12 and 13 Effect of Rotation

There are 8 loss triangles with a total area

$${A}_{loss} = 4 {( \frac{x}{2} )}^{2} tan {0.00955}^{∘}$$

(with x as the Length of the Side of the Square).

The relative error in each case is 0.016%.

For the error by rotation in analysis of a single window, this relative error of less than 0.02% is not considered, but in the case considered for the image processing method, it would be considered, since only there is compensation by the camera possible.

4.2.2 Matrix Analysis

The maximum matrix size of 128 mm×128 mm and a positioning of an (actual) 1.45 mm×1.2 mm large window in a corner of this matrix is presumed, the arising error can be estimated by the following analysis:

FIG. 14 Effect of Rotation

To a first approximation the window now has no longer dimensions of 1.45 mm×1.20 mm, but only 1.45 mm×1.1787 mm, which corresponds to a surface covering error of less than 1.8%. Since, under worst-case conditions, the common contact surface drops by less than 1.8%, for the matrix analysis, the rotation error in the robot gripper can be ignored. It could be further reduced in the positioning method with image processing.

### 5. Center Point Crosses for the Conventional (but Unpublished) Method

During consideration in the coordinate system, the center point crosses of the individual windows or their displacement by the individual errors can be used.

FIG. 15 Combination of Individual Errors

### 6. Summary of the Conventional, Unpublished Method in a Single Window Analysis

A resulting window size of 1.45 mm×1.20 mm is presumed by the initial data error. The coincidence error limits the maximum contact surfaces for a square with 1.2 mm×1.2 mm sides. Therefore, that the stop error will be present in each of the two workpieces must be dealt with and therefore appears in the calculation twice. It is further assumed that the robot error in each workpiece is the worst possible in the accuracy calculation.

| | | | % of original |
|---|---|---|---|
| Error type | Frequency | Window size | surface |
| Initial data error | Twice | 1.45 mm × 1.20 mm | 77.33% |
| After coincidence error | Once | 1.20 mm × 1.20 mm | 64.00% |
| After stop error | Twice | 1.09 mm × 1.09 mm | 52.80% |
| After robot error | Twice | 0.991 mm × 0.991 mm | 43.65% |

### 7. Summary of the Image Processing Method in the Single Window Analysis

As in the conventional, unpublished method, the conditions for flat flexible cable production are also relied on in the image processing method, and the initial data errors must be used as starting values. For the single window analysis, the coincidence error can be compensated in that the center point crosses are covered by the upper and lower workpiece. The robot error enters into the accuracy calculation only once, since the compensation cannot be carried out during image processing only for the second workpiece. An overlapping surface that can be sketched as follows is obtained.

FIG. 16 Situation of the Single Window

For this method, the camera error KF (difference between reality and the digital image) enters into the accuracy twice, since each of the two workpieces is “measured.” The resulting total contact surface could now be stated by the following formula:

for KF≦0.03755 mm: relative covering surface=64%

for KF>0.03775 mm:

$$relative covering surface = \frac{{( 1.2 - \vert 0.0755 - 2 K F \vert )}^{2}}{{1.5}^{2}} ( 100 \% )$$

For a worst case camera error of 0.025 mm, it is also found that the lateral “overlapping reserves” are large enough and the common contact surface is not restricted by the camera error.

| | | | % of original |
|---|---|---|---|
| Error type | Frequency | Window size | surface |
| Initial data error | Twice | 1.45 mm × 1.20 mm | 77.33% |
| After coincidence error | Once | 1.20 mm × 1.20 mm | 64.00% |
| (with compensation) | | | |
| After robot error | Once | 1.20 mm × 1.20 mm | 64.00% |
| After camera error | Twice | 1.20 mm × 1.20 mm | 64.00% |

For the single window analysis, a worst case improvement of 31.80% can be stated for the image processing method relative to the conventional method.

The following analysis of the center cross makes it clear how small the deviations from the error now are:

FIG. 17 Combination of Individual Errors

### 8. Multi-window Matrix Consideration with the Conventional Method

The worst case in multi-window matrices (practical case) can be sketched as follows:

FIG. 18 and 19 Theoretical Situation in Several Windows

In this case, all windows drift apart at the maximum tolerances in a cable and, on the other flat flexible cable, the windows join to a minimum. For a window originally 1.5 mm×1.5 mm in size, which was reduced by the manufacturing tolerances to 1.45 mm×1.20 mm, the following overlap thereby occurs:

FIG. 20, 21, 22, 23 and 24 Effect on Individual Windows

During matrix consideration, an additional coincidence error of 10.54% can therefore occur, which finally reduces the contact surface to a 1.135 mm×1.135 mm square. The surface of the contact square now corresponds to only 57.25% of the original surface.

Here again, the stop error for both cables can occur and the contact surface is therefore reduced to 45.79% of the original surface.

The robot error gain occurs twice and results in a reduction of contact surface to a 0.916 mm×0.916 mm square, whose size corresponds to 37.29% of the original size.

If a certain connection error that has the same deviation as the robot error is included in the calculation, the surface of the joint copper-copper connection is 0.8665 mm×0.8665 mm and therefore 33.37% of the original covering surface.

| | | | % of original |
|---|---|---|---|
| Error type | Frequency | Window size | surface |
| Initial data error | Twice | 1.45 mm × 1.20 mm | 77.33% |
| After coincidence error | Once | 1.135 mm × 1.135 mm | 57.25% |
| After stop error | Twice | 1.015 mm × 1.015 mm | 45.79% |
| After robot error | Twice | 0.916 mm × 0.916 mm | 37.29% |

### 9. Multi-window Matrix Consideration for the Image Processing Method

If one again takes the case of maximally separated windows on a workpiece and the maximum overlying windows on the other workpiece for the analysis, the coincidence error can be reduced by image processing. The procedure is to reduce the fairly large errors in the right lower window at the expense of the other windows, and thus carry out error compensation in all windows. In the worst case, this error compensation corresponds to a translation of the upper flat flexible cable by 0.0375 mm to the left and up. The overlappings mentioned under point 8 will lead to overlaps of the following structure by this translation:

FIG. 25, 26, 27 and 28 Effects on Individual Windows

The worst case for the contact surface square therefore lies at 1.1725 mm×1.1725 side length and therefore a contact surface of 61.10% of the original surface.

In the method with image processing, this stop error is not included in the accuracy calculation; this error is compensated by image processing.

The robot error need only be considered once, when, namely, the second flat flexible cable is positioned on the first cable after analysis by the camera. If the effects of this one robot error are subtracted from the contact surface, a copper-copper coincidence surface of 56.05% of the original surface is obtained (1.123 mm×1.123 mm, instead of 1.5 mm×1.5 mm).

The camera errors must now still be considered twice. In order to be better than the worst case in the conventional case with 0.916 mm×0.916 mm, the camera error must be less than 0.1035 mm, relative to the TCP. The camera test, in practice, confirms a deviation of 0.025 mm as the worst case error.

| | | | % of original |
|---|---|---|---|
| Error type | Frequency | Window size | surface |
| Initial data error | Twice | 1.45 mm × 1.20 mm | 77.33% |
| After coincidence | Once | 1.1725 mm × 1.1725 mm | 61.10% |
| error (with | | | |
| compensation) | | | |
| After robot error | Once | 1.123 mm × 1.123 mm | 56.05% |
| After camera error | Twice | 1.073 mm × 1.073 mm | 51.17% |

For the matrix analysis occurring in practice, the increase in common copper-copper contact surface and therefore the improvement in accuracy is 27.12%.

Matrix consideration of the conventional (but not previously published) method

FIG. 29, 30, 31 and 32 Overlap of the Windows in the Conventional Method

A detailed drawing follows from the lower right window for more comprehensible representation:

Dashed square—ideal square with 1.5 mm×1.5 mm

Dotted lines—diagonals of the ideal square and resulting contact surface square for determination of the center crosses

Center cross of the remaining contact surface to the right and up relative to the ideal center cross.

FIG. 33 Overlap of the Windows in the Conventional Method

Matrix Consideration Image Processing Method

FIG. 34, 35, 36 and 37 Overlap of the Windows in the Image Processing Method Conventional (Unpublished) Method:

| | | | % of original |
|---|---|---|---|
| Error type | Frequency | Window size | surface |
| Initial data error | Twice | 1.45 mm × 1.20 mm | 77.33% |
| After coincidence error | Once | 1.135 mm × 1.135 mm | 57.25% |
| After stop error | Twice | 1.015 mm × 1.015 mm | 45.79% |
| After robot error | Twice | 0.916 mm × 0.916 mm | 37.29% |

Image Processing Method

| | | | % of original |
|---|---|---|---|
| Error type | Frequency | Window size | surface |
| Initial data error | Twice | 1.45 mm × 1.20 mm | 77.33% |
| After coincidence | Once | 1.1725 mm × 1.1725 mm | 61.10% |
| error (with | | | |
| compensation) | | | |
| After robot error | Once | 1.123 mm × 1.123 mm | 56.05% |
| After camera error | Twice | 1.073 mm × 1.073 mm | 51.17% |

Summary of the Comparison

| Error type | Conventional method | Image processing method |
|---|---|---|
| Initial data error | 77.33% | 77.33% |
| After coincidence error | 57.25% | 61.10% |
| After stop error | 45.79% | — |
| After robot error | 37.29% | 56.05% |
| After camera error | — | 51.17% |

As is clearly apparent from the above comments, the invention creates, by its measures:

Optical detection of the stripped sites of the two flat flexible cables being joined, both according to position on the corresponding flat flexible cable and according to their shape and size, superimposition so that the (relatively) smallest overlapping stripped surface is a maximum, and a positioning of the tool on the machine is achieved that produces the electrical connection in the center of the overlapping stripped surface, whereby a reduction of the actual contact surface by orders of magnitude, and therefore a significant reduction in electrical resistance and a significant increase in mechanical strength.

As the “relatively smallest surface,” the smallest surface need not necessarily be considered, but mostly the surface that is considered most critical as a result of the width of the copper conductor being connected and/or the prescribed specific current load, and this therefore need not be the smallest surface with the pure surface dimension. For example, if two geometrically identical large overlapping surfaces are present with different current load, the surface with the higher current load to be expected is the “relatively smaller surface.”

The invention is not restricted to the described examples, but can be modified in a variety of ways. By corresponding adaption of the formula, which can easily be carried out by one skilled in the art with knowledge of the invention, a corresponding application for flat flexible cables to be joined obliquely relative to each other (and not at right angles, under 90°) can be obtained. The invention is applicable to all types of robots and flat cables (laminated and extruded, with identical copper conductors or with different ones, etc.); stripping of the insulation can occur in a wide variety of ways, although, in the application, laser removal of the insulation was contemplated, in particular. The form of the stripped surfaces need not be rectangular, and circular or oval forms are likewise possible.

It must also be kept in mind that execution of the method according to the invention and comparison to the internal prior art occurred by means of a special practical example, in which tolerances were used as they occur in practice. Naturally, during comparisons of examples with other tolerances, other possible improvements were obtained; however, it is readily apparent from the example how an automatic connection of FFCs is possible by optical recognition in combination with the method according to the invention.

The question of “center” of the overlapping stripped surface can be answered either by selecting the center of mass or by another choice adapted to the corresponding connection method; it is possible, for example, to conduct an emphasis with a linear or quadratic weighting, in order to consider special requirements. In particular, in complexly-shaped overlapping surfaces, to simplify the cutting point, the shortest one with the longest fiber or the like can be used. The use of specially shaped tool tips, which again make a specific selection possible and necessary, is also conceivable.

All devices that are capable of manipulating an FFC with repeatable accuracy (grasping, movement, depositing) and can be controlled by an electronic control means are considered as robots. Whether grasping occurs by suction cups or clamps, in principle, is inconsequential.

The invention also concerns a device for execution of the method that includes at least one robot that can handle the FFC, a fastening device for the positioned FFC on a carrier, a camera, a device that produces the electrical connection and a control device for the robot that also processes the signals coming from the camera. The control device need not be a physical unit and, in the description and claims, the sum of (mostly electronic) components and devices, together with their sensors, are also understood as a control device, which permit overall performance of the method according to the invention described above.

Since positioning of the FFC in the final position occurs after optical detection, without necessarily using the stop, the FFCs need only be fixed in their final position, which is possible, for example, by suction devices, by pressure devices, etc., which are preferably mounted on the carrier.

The carrier can be a flat plate (for example, a work table) or have the shape of an elongated support surface, for example, the surface of an extruded profile. The fastening devices are preferably mounted on the carrier, so that any unrecognized and therefore undesired movement of the FFC during fastening is prevented and minimized in the simplest manner. For this purpose, the FFC is deposited and secured on the carrier by the robot and the fastening devices (the plural is always used here in the description without this being technically necessary) are then activated, and only then does the robot release the now fastened FFC.

The second FFC is also deposited, preferably in the same way as the first FFC, after calculation of the desired end position, and fastened by fastening devices allocated to it before its release by the robot.

The tool of the connection device is then brought into the desired position and activated, so that it produces the electrically conducting and mechanical connection between the two FFCs by joining the exposed strip conductors brought into contact with each other at a first window. The tool is then brought into the matching position for connection in the region of the second window and activated, etc., until the strip conductors of all windows of the matrix are connected to each other. The sequence is then preferably executed from the smallest overlapping surface to the largest, in order to cause no changes in the relative position of the FFC as a result of heat expansion, etc. in the most critical connection(s).

After formation of all connections, the finished part is grasped by the robot (or another robot), released by the fastening devices and transported for further use.

1. Method for positioning of stripped sites of two flat flexible cables (FFC) to be electrically and mechanically connected to each other, characterized by the fact that the stripped sites of the two flat flexible cables to be connected are optically detected, both in terms of their position on the corresponding flat flexible cable, and also in terms of their shape and size, that they are placed one on the other, so that the smallest of the overlapping stripped surfaces becomes a maximum.

2. Method for positioning of the stripped sites of two flat flexible cables (FFC) to be mechanically and electrically connected to each other, characterized by the fact that the stripped sites of the two flat flexible cables being connected are optically detected, both in terms of their position on the corresponding flat flexible cable, and also according to their shape and size, that they are placed one on the other, so that the largest current density occurring in one of the overlapping stripped surfaces becomes a minimum.

3. Method according to claim 1, characterized by the fact that the tool of the machine that produces the electrically conductive connection is mounted in the center of each overlapping stripped surface.

4. Method according to claim 3, characterized by the fact that the center of the overlapping stripped surfaces is their center of mass.

5. Method according to claim 3, characterized by the fact that the center of the overlapping stripped surfaces is their center of mass with, for example, a linear or quadratic weighting.

6. Method according to claim 3, characterized by the fact that the center of the overlapping stripped surfaces is the cutting point between the longest fiber of the surface and the shortest fiber of the surface.

7. Method according to claim 1, characterized by the fact that the connection method is a welding method.

8. Method according to claim 1, characterized by the fact that the first connection occurs in the smallest of the overlapping stripped surfaces.

9. Method according to claim 8, characterized by the fact that connection of the next larger overlapping stripped surface occurs in sequence.

10. Apparatus for execution of the method according to claim 1, characterized by the fact that the apparatus has a carrier for depositing the FFC, a robot for handling the FFC, at least one fastening device for each FFC positioned on the carrier, a camera, a connection device that forms an electrical connection between the strip conductors of the FFC and a control device for the robot and the fastening devices, which also processes the signals from the camera.

11. Apparatus according to claim 10, characterized by the fact that the fastening device is mounted on the carrier.
